(19) United States
(12) Patent Application Publication
(10) Pub. No.: US 2008/0299161 A1
(43) Pub. Date: Dec. 4, 2008

(54) Solid Biocide Composition and Sealed Biocide Article

(76) Inventor: William D. Sanderson, San Francisco, CA (US)

Correspondence Address: MANELLI DENISON & SELTER, 2000 M STREET NW SUITE 700, WASHINGTON, DC, 20036-3307, US

(21) Appl. No.: 12/091,785

(22) PCT Filed: Dec. 15, 2006
(86) PCT No.: PCT/US2006/047729

§ 371 Date: Apr. 28, 2008

Related U.S. Application Data
(60) Provisional application No. 60/750,786, filed on Dec. 16, 2005.
(60) Provisional application No. 60/812,632, filed on Jun. 12, 2006.

(51) Int. Cl. A01N 25/34; A01N 59/08; A01P 15/00

(52) U.S. Cl. 424/408; 424/661

(57) ABSTRACT

A solid composition for forming chlorine dioxide on demand and a sealed biocide article.

This application claims priority to U.S. Provisional Patent Application Ser. Nos. 60/812,632, filed Jun. 12, 2006 and 60/750,786, filed Dec. 16, 2005, the complete disclosures of which are incorporated herein by reference.

### FIELD OF THE INVENTION

The invention relates to a solid biocide composition. The composition rapidly releases chlorine dioxide when contacted with water or moisture. The invention also relates to a sealed biocide article.

### BACKGROUND OF THE INVENTION

Chlorine dioxide is a highly reactive yellowish-green gas that produces useful aqueous solutions in a number of applications such as disinfection, sterilization, and odor control. It is a potent antimicrobial agent, bleaching agent, and as a germicide has found increasing receptivity of its use in municipal and drinking water treatment, cooling towers, and food processing.

Recent regulatory approvals have led to growing acceptance of its use in reducing pathogens in food processing applications such as poultry chill water tanks, beef and pork carcasses washes, and raw agricultural commodities.

Chlorine dioxide has many advantages over traditional chlorine-based biocides due to its greater selectivity towards bacterial cell membranes. However, several drawbacks have limited the implementation of chlorine dioxide where its superior safety and environmental profile would benefit a wide variety of industries.

### PRIOR ART OF SOLID COMPOSITIONS

The prior art describes methods to produce chlorine dioxide from dry compositions such as tablets, powders, and briquettes. The prior art has been extensively covered in published U.S. patent appl'n ser. No. 2004/0135116, which is incorporated herein by reference.

U.S. Pat. No. 6,602,442 describes a “dry composition” comprising lithium hypochlorite, sodium chlorite, and sodium hydrogen sulfate. Although this mixture was found to very soluble and rapidly yield chlorine dioxide upon addition to water, a substantial amount of chlorine gas is undesirably released since chlorine is produced above its solubility in water. See column 2, line 55-56 of this patent. Furthermore, the stability of the dry mixture is limited, especially in high humidity environments. These limitations preclude the addition of large amounts to water since the excess chlorine production would cause the mixture to “flash”.

Published U.S. patent appl'n ser. No 2004/0135116 and U.S. Pat. No. 6,699,404 describe solid chlorine dioxide releasing “massive bodies,” which comprise a mixture of granular particulate ingredients where the size of the particles is substantially smaller than the size of the massive body. The massive body is formed from the mixture of particulate ingredients by compression and is essentially a large tablet. The tablets release chlorine dioxide and free chlorine when added to liquid water. The patent claims a composition of a chlorite salt, an acid source, and free halogen source, with the preferred composition being sodium chlorite, sodium bisulfate, and the sodium salt of dichloroisocyanuric acid.

Published US 2005/0249658 B2 describes a solid chlorine dioxide releasing composition having increased temperature stability. The increased temperature stability is provided by using a combination of two chlorine-releasing agents: sodium dichloroisocyanurate and a hypochlorite salt. The application also teaches that using an acidulant with a pKa of 2.8-6.0 further enhances temperature stability.

A halogen-enhanced oxidizing composition and a solvent activated reactor are described in published applications US 2005/0155936A1 and US 2006/0013751 A1. Solid oxidizing compositions including chlorine dioxide are described. The application describes the use of a metal chlorite, oxidizing agent, and chloride salt to produce chlorine dioxide.

US 2006/0016765 A1 describes a composition for producing chlorine dioxide comprising an active oxygen compound and a chlorine dioxide-generating compound. See paragraph 23. Preferred active oxygen compounds are sulfur-containing oxy-acid compounds. See paragraph 26. Suitable precursors for producing chlorine dioxide include chlorite salt, alkali metal salt or alkaline earth halide salt. See paragraph 26. The preferred composition is sodium chlorite, potassium monopersulfate, and magnesium chloride. This publication discloses a large list of metal halides, which can be added as a “catalyst to speed up generation of chlorine dioxide” of which zinc bromide is listed. See paragraphs 42. However, the zinc bromide was used at a pH of 4.1. See Table 1. Furthermore, the publication teaches that calcium bromide at a pH of 3.7 is a “comparative example C,” i.e. does not work, and it gives an orange color which may interfere with results, thus, teaching away from using calcium bromide. See Table 1. Furthermore, this publication does not teach forming hypobromous acid at a pH of 5-9 or the many advantages thereof.

There is a need for a solid biocide composition that rapidly produces chlorine dioxide in the presence of water or moisture on demand, without producing substantial amounts of chlorine gas or other undesired compounds.

### OBJECTS OF THE INVENTION

The generation of chlorine dioxide from a chlorite salt using a weak hypohalous acid with a pKa value of about 8.6 as the oxidizing species.

The generation of chlorine dioxide from a chlorite salt using a weak hypohalous acid with an acidity constant of 2.3×10⁻⁹.

Generating the ionic species OCl⁻ and/or OBr⁻ when the present invention is contacted with water or moisture.

Generating the ionic species HOCl and/or HOBr when the present invention is contacted with water or moisture.

The generation of chlorine dioxide from a chlorite salt using a weak hypohalous acid with an oxidation capacity of 1.33 electron volts as the oxidizing species.

The generation of hypohalous acid to form chlorine dioxide from a chlorite salt using a monopersulfate oxidizing agent with an oxidation capacity of 1.44 electron volts.

The generation of chlorine dioxide at a reaction pH from 5.0-9.0 using an oxidizing agent, a chlorite salt, and a bromide salt.

The generation of chlorine dioxide where a liquid halogen with a deep reddish brown color is formed as an intermediate step to formation of chlorine dioxide. The liquid halogen is heavier than water and is found at the bottom of the reaction vessel.

The generation of chlorine dioxide where a liquid halogen is formed and has an atomic number of 35.

The generation of chlorine dioxide where a bromine-like odor is formed prior to the characteristic chlorine dioxide odor.

The generation of chlorine dioxide where acidulant materials are not required to maintain a pH less than 5.0.

A solid biocide composition that does not possess a chlorine-like odor.

A solid biocide composition that does not contain a free halogen releasing compound in the composition. A free halogen releasing compound is defined where if added to water it will generate measurable free halogen.

A solid biocide composition consisting of only inorganic chemicals or where the carbon atom is not present in the formula.

The generation of chlorine dioxide using any compound that produces hypobromous acid upon contact with water or seawater.

To produce a solid biocide article that is not subject to degradation by moisture, oxygen, and temperature.

To produce a solid biocide article that is not subject to premature release of chlorine dioxide and active oxygen by moisture and temperature.

A structure that preserves the active oxygen content of the composition.

To produce a biocide article that is not subject to premature release of chlorine dioxide by accidental spillage or leakage of moisture, water, or other aqueous fluids.

To produce a solid biocide article that is not subject to premature yellowing of the composition or packaging material.

To produce a solid biocide article that is safe to handle and does not require direct exposure to skin.

### SUMMARY OF THE INVENTION

An embodiment of the present invention relates to a solid biocide composition that rapidly generates chlorine dioxide upon addition to water or moisture.

Another embodiment of the invention relates to a sealed biocide article comprising the biocide composition sealed between two layers of a high-barrier material. The composition of the sealed biocide article is detailed below.

The current invention relates to a novel chemical pathway to generate chlorine dioxide from solid ingredients. It utilizes an oxidation pathway employing a bromide salt or bromine-releasing agent and its corresponding hypohalous acid product, hypobromous acid. The formed hypobromous acid then provides the oxidative potential to generate chlorine dioxide from its chlorite salt.

Chlorine dioxide generation in the prior art commonly utilizes the intermediate reactant species hypochlorous acid as the oxidizing species to convert chlorite salt to chlorine dioxide. Hypochlorous acid can be formed from a number of solid ingredients, usually chlorinated isocyanurates, chlorinated hydantoins, alkali or alkali earth metal hypochlorites, or metal chloride salts reacted with active oxygen compounds, such as potassium monopersulfate.

In the present invention, when hypobromous acid is instead utilized as the oxidizing species, the conversion of the chlorite salt to chlorine dioxide occurs rapidly at a neutral pH (preferably about 6.5 to about 7.5) compared when using hypochlorous acid. A rapid and high yield of chlorine dioxide is released when hypobromous acid is produced in the presence of chlorite ions.

The unique reaction is clearly visible as a brown liquid heavier than water and is formed immediately upon the addition of the composition to water. The brown liquid collects on the bottom of the reaction vessel forming a thin layer over the solid composition. The brown liquid is believed to be the halogen, bromine. As the reaction continues, the characteristic yellow color of chlorine dioxide is quickly visible and increases until the brown color completely disappears. In less than 5 minutes, the chlorine dioxide solution is a bright yellow color and has reached its maximum concentration.

This surprisingly enhanced chlorine dioxide releasing effect is believed to occur because of the different pKa values of the two weak acids. Hypobromous acid has a pKa of 8.6 compared to a pKa of 7.5 for hypochlorous acid. At a pH of 7.5, less than 50% of the active oxidizing agent HOCl is present, compared to 94% for HOBr. The hypochlorous acid pathway reactions utilized in the prior art require the use of additional acidulant materials to ensure rapid conversion of the chlorite ion to chlorine dioxide. The hypochlorous acid releasing formulations also generate free chlorine in the solution that is not converted to chlorine dioxide. This is a disadvantage is applications that require the reaction to be entirely chlorine-free.

The oxidizing effect of the two hypohalous acids can be easily demonstrated by comparing chlorine dioxide generation using a bromide salt and a chloride salt. The reaction when sodium bromide is oxidized to hypobromous acid, in the presence of sodium chlorite, occurs very rapidly and generates a 2-3 fold greater yield of chlorine dioxide, compared when oxidizing sodium chloride under the same conditions. The surprising result is an increased yield and a shorter reaction time required to attain maximum chlorine dioxide release.

The greater yield of chlorine dioxide is also believed to occur because the reaction intermediate, bromine and hypobromous acid, are heavier than water and collect at the bottom of the reaction vessel near the reaction site of the solid composition. A thin layer of bromine was observed to cover the solid reactants on the bottom of the flask. It is believed that these phenomena contributed to the conversion speed and rate of the chlorite ions to chlorine dioxide. Therefore it is believed that the slower diffusion rate of bromine compared to that of chlorine used in prior art compositions contributed to the observed higher yield of chlorine dioxide.

To illustrate this point, consider the prior art of U.S. Pat. No. 6,699,404. It is stated that the high conversion rate results from the use of tablets because a pore structure develops and produces a substantially saturated acidic solution of chlorite anion. It also states that once the reactants have dissolved into solution, further conversion of chlorite anion to chlorine dioxide is very small.

Therefore without being bound by any theory, it is believed in the current invention that the slow diffusion rate of the intermediate bromine and the lack of need for an acidic solution, since hypobromous acid (HOBr) operates effectively at neutral pH, contribute to the greater yield and increased rate of chlorine dioxide conversion.

The current invention also pertains to packaging of the solid biocide composition. It was found that stability problems existed in many of the solid prior art compositions referenced above. The “massive body” mentioned in U.S. Pat. No. 6,699,404 was found to undergo extensive yellowing-effect in humid conditions (moisture >40%). The composition of U.S. Application No. 2006/0016765 A1 was found to be even more reactive in humid conditions and substantial release of chlorine dioxide was observed. The mixture described in U.S. Pat. No. 6,602,442 also exhibited premature release of chlorine dioxide gas. The current invention addresses stability concerns and describes a method of extending the useful shelf-life of solid mixtures and compressed solid mixtures of chlorine dioxide precursor materials.

### BRIEF DESCRIPTION OF THE DRAWINGS

FIG. 1 illustrates a top view of a blister pack according to the present invention;

FIG. 2 illustrates a side view of a blister pack according to the present invention; and

FIG. 3 illustrates a side view of a strip pack according to the present invention.

### DETAILED DESCRIPTION OF INVENTION

### A. Composition of the Invention

The composition comprises a solid source of source of hypobromous acid and a solid source of chlorite. The active ingredients of the composition are selected and present in amounts such that the pH of a solution formed from dissolving the composition in water is from about 5 to about 9, preferably from about 5.5 to about 8.5, and more preferably about 6 to about 8, and most preferably about 6.5 to 7.5, measured at 25° C. at a concentration of 1 g of active ingredients of the composition per 100 ml of water. The active ingredients being the solid source of hypobromous acid and the solid source of chlorite.

The solid source of chlorite comprises an alkali or alkali earth metal chlorite. The solid source of hypobromous acid comprises an oxidizing agent and a solid bromide releasing compound.

The alkali or alkali earth metal chlorite can be any as desired, such as sodium, potassium, lithium, calcium, zinc, or magnesium chlorite, which are commercially available.

The composition typically contains from about 10 to about 90% of solid source of hypobromous acid and about 10 to about 90% of solid source of chlorite. All percentages are weight percentage based on the total weight of the composition unless otherwise stated.

A preferred composition comprises from about 10 to about 90% of sodium chlorite, about 5 to about 90% of sodium bromide, and about 5 to about 60% of potassium monopersulfate. More preferably, the composition comprises about 20 to about 60% sodium chlorite, about 10 to about 40% of sodium bromide, and about 10 to about 50% of potassium monopersulfate. All percentages are weight percentage based on the total weight of the composition unless otherwise stated.

Oxidizing agents are typically acidic in nature. Thus, preferably the amount of oxidizing agent is from about 5 to about 50%, more preferably from about 10 to about 40%, and most preferably from about 10 to about 30% of the composition, based on the total weight of the oxidizing agent, chlorite and bromide-releasing compound. In the case of a compound that is both an oxidizing agent and a bromide-releasing compound then the amount is based on the total weight of the chlorite and the compound.

Suitable examples of oxidizing agents include alkali and alkali earth metal persulfates, monopersulfates, and ammonium persulfate; alkali and alkali earth peroxides such as lithium, sodium, potassium, calcium, zinc, or magnesium peroxide, urea peroxide, percarbonates, persilicates, perphosphates and their metal salts, and hydrogen peroxide. The preferred oxidizing agent is potassium monopersulfate.

Other example of peroxides other than hydrogen peroxide include dialkylperoxides, diacylperoxide, performed percarboxylic acids, organic and inorganic peroxides, and/or hydroperoxides. Suitable organic peroxides/hydroperoxides include diacyl and dialkyl peroxides such as dibenzoyl peroxide, t-butyl hydroperoxide, dilauroyl peroxide, dicumyl peroxide, and mixtures thereof. Suitable peroxy-acids for use in the compositions include diperoxydodecandioic acid (DPDDA), magnesium perphthalic acid, perlauric acid, perbenzoic acid, diperoxyazelaic acid and mixtures thereof.

Suitable examples of bromide salts include alkali and alkali earth metal bromides such as sodium bromide, lithium bromide, potassium bromide, magnesium bromide, ammonium bromide, zinc bromide, calcium bromide, and aluminum bromide.

Other examples of bromide salts include mixtures of bromine-rich salts commonly found in nature such as the Dead Sea salts and brines. These contain bromide salt in combination with other common salts such as sodium chloride, potassium chloride, magnesium chloride, zinc chloride, sodium sulfate, potassium sulfate, magnesium sulfate, sodium iodide, potassium iodide, and the like. Any combination of salts can be used as the bromide source.

Other exemplary combinations include: a bromide salt combined with a chloride or iodide salt. For example: bromide salt+sodium, potassium, lithium, magnesium, calcium, zinc, ammonium, or aluminum chloride. Or for example an iodide salt of sodium, potassium, lithium, calcium, magnesium, zinc, ammonium, or aluminum can also be used. All can be used individually or in combination in the current invention.

The source of the halide salts required to produce the hypohalous acid can also be present in the water which is to be treated. For example, seawater which consists of about 3.5% salt can be used as the sole source of the halide salt. The chlorine dioxide releasing composition then can be reduced to two parts: chlorite source and the oxidizing agent. This unexpected result was found when adding sodium chlorite and potassium monopersulfate to seawater (See Experimental Example 6).

Also suitable are bromide-releasing compound in which the bromide ion is a salt of a suitable organic cation, such as for example, but not limited to ammonium bromide, alkylammonium bromide, dialkylammonium bromide, trialkylammonium bromide, wherein said alkyl radicals are independently selected from straight chain or branched aliphatic, aromatic, or aryl hydrocarbon radicals of between 1 to about 24 carbon atoms.

Also suitable as a bromide-releasing compound are bromide ion exchange materials. That is materials able to exchange a bromide ion in the presence of the more common chloride ion in aqueous solution, and which are typically water insoluble polymeric and mineral matrixes preloaded with high bromine ion content.

Ideally the salt should form hypobromous acid during oxidation with potassium monopersulfate. Some salts or mixtures of salts will form a combination of hypobromous, hypochlorous, and/or hypoiodous acid. Hypochlorous acid is also a powerful oxidizing agent and will convert additional bromide salt to hypobromous acid.

Other forms of bromine-releasing compounds may also be used. The below compounds provide free bromine and the corresponding hypobromous acid when added to liquid water. They can also serve as oxidizing agents to convert bromide salts to free bromine. Also suitable to provide free bromine is liquid bromine in elemental form. This is a dark liquid at room temperature and standard pressure.

### Hypohalite-Generating Compound

A hypohalite-generating compound can provide the oxidation potential to oxidize sodium chlorite to chlorine dioxide. A hypohalite-generating compound can also produce free bromine from bromide ions in aqueous solution. Suitable compounds for providing the free available halogen concentration are hypochlorite-generating or hypobromite-generating compounds. These compounds must be at least partially or fully water soluble and generate an active halogen ion (ie. HOCl, HOBr, OCl⁻, OBr⁻) upon dissolving in water. Thus, the hypohalite-generating compound can be considered as both the oxidizing agent and the bromide-releasing agent.

Any of the following representative sources or mixtures thereof include alkali and alkali earth metal hypobromite salts such as: lithium hypobromite, sodium hypobromite, potassium hypobromite, calcium hypobromite, magnesium hypobromite, and zinc hypobromite.

Also suitable hypochlorite-generators are chlorinated trisodium phosphate, chlorinated trisodium polyphosphate, and chlorinated trisodium phosphate dodecahydrate, and mixtures thereof.

Any of the following representative sources or mixtures thereof including alkali and alkali earth metal hypochlorite salts such as lithium hypochlorite, sodium hypochlorite, potassium hypochlorite, calcium hypochlorite, magnesium hypochlorite, and zinc hypochlorite are also suitable.

### Halocyanurates

Any of the following representative sources of halocyanurates or mixtures thereof including but not limited to their lithium, sodium, potassium, calcium, magnesium, or zinc salts may be used in the current invention. Tribromoisocyanuric acid, dibromoisocyanuric acid, monobromoisocyanuric acid, monobromo-dichlorisocyanuric acid, dibromo-monochloroisocyanuric acid, and monobromo-monochloro-isocyanuric acid may be used to produce a free bromine and its corresponding hypobromous acid when added or contacted with water.

Also suitable hypobromite-generating compounds include: 1,3,5-Triazine-2,4,6(1H,3H,5H)-trione, 1,3-dibromo-, sodium salt (sodium dibromoisocyanurate—CAS #15114-34-8); and 1,3,5-Triazine-2,4,6(1H,3H,5H)-trione, 1,3-dibromo-, potassium salt (potassium dibromoisocyanurate—CAS #15114-46-2).

Also suitable hypobromite-generating compounds include: 1,3,5-Triazine-2,4,6(1H,3H,5H)-trione, 1-bromo-3-chloro-, sodium salt (sodium bromochloroisocyanuric acid—CAS #20367-88-8); and 1,3,5-Triazine-2,4,6(1H,3H,5H)-trione, 1-bromo-3-chloro-, potassium salt (potassium bromochloroisocyanurate—CAS# 29545-74-2).

Also 1,3,5-Triazine-2,4,6(1H,3H,5H)-trione, 1,3-dibromo-5-chloro-(bromochlorisocyanuric acid—CAS #666714-66-5); and 1,3,5-Triazine-2,4,6(1H,3H,5H)-trione, 1,3-dibromo-(dibromocyanuric acid—CAS #15114-43-9); and sodium monobromo-monochloro-isocyanurate (bromochloroisocyanuric acid monosodium salt hydrate—CAS #164918-61-0) are suitable.

Additional suitable hypobromite-generating organic compounds include N-bromophthalamide, N,N-dibromodimethylhydantoin, N,N-dibromodiethylhydantion, N,N-dibromodimethylglycoluracil, dibromotriethylene-diamine dihydrogenchloride, and mixtures thereof.

Suitable hypochlorite-generating compounds include: Trichlorocyanuric acid, dichlorocyanuric acid, mono-chlorocyanuric acid, sodium dichloroisocyanurate (dihydrate and anhydrous), and potassium dichloroisocyanurate.

Also suitable hypochlorite-generating compounds including but not limited to N,N-dichloro-s-trizinetrione, N-chlorophtalamide, N-dichloro-p-toluene sulfonamide, 2,5-N,N-dichloroazodicarbonamidine hydrochloride, NNNN-tetrachloroglycoluracil, N,N-dichloroyl,N,N,N-trichloromelamine, N-chlorosuccinimide, methylene-bis(1-chloro-5,5,-dimethyethylhydantoin), 1,3-dichloro-5-methyl-5-isobutylhydantoin, 1,3,dichloro-5-n-amylhydantoin, 1,3-dichloro-5,5-dimethylhydantoin, 1,4-dichloro-5,5-diethylhydantoin, 1-1monochlor-5,5-dimethylhydantoin, sodium-para-toluenesulfochloramine, dichlorosuccinamide, 1,3,4,6-tetrachlorogylcouracil, potassium and sodium salts of chloroisocyanuric acid, dichloroisocyanuric acid, potassium and sodium salts of N-brominated and N-chlorinated succinimide, malonimide, phthalimide and naphthalimide, and mixtures thereof.

Halohydantoins, such as 1-bromo-3-chloro-5,5-dimethylhydantion (BCDMH), 1-bromo-3-chloro-5-methyl-5-ethyl-hydantoin (BCEMH), 1,3-dibromo-5,5-dimethylhydantoin (DBDMH), 1,3-dibromo-5-methyl-5-ethyl-hydantoin (DBEMH) are suitable.

Other suitable N-haloamines are trichloromelamine, tribromomelamine, dibromo- and dichloro-dimethyhydantoin, chlorobromo-dimethylhydantoin, N-chlorosulfamide (haloamide), chloramines (haloamine), and mixtures thereof.

Also suitable are partially chlorinated and brominated compounds, including N-bromo-N-chlorodimethylhydantion, N-bromo-N-chlorodiethylhydantoin, N-bromo-N-chlorodiphenylhydantoin, N-bromo-N,N-dichloro-dimethylglycouracil, N-bromo-N-chlorosodium cyanurate, bromochlorotriethylenediamine dihydrogenchloride and mixtures thereof.

The composition can contain other ingredients as desired. For example, if the composition is formed into a tablet, common ingredients such as binders, mold release agents, compression aids, tablet lubricants, swelling agents, carrier materials, fillers, and surfactants can optionally be added to the composition.

### B. Structure

The composition can be produced by any method known to one skilled in the art such as mixing, blending, granulating, pelleting, tableting, or extruding. The preferred method is tableting, which is carried out by methods familiar to one skilled in the art. Tablets provide a convenient form of example to demonstrate the second embodiment of the invention, which comprises a sealed biocide article comprising the claimed composition sealed in a high-barrier package.

The invention will be further described with reference to a tablet, without being limited thereto. The stability of the composition in tablet form is a function of two factors: 1) Keeping moisture away from the tablet to prevent premature release of chlorine dioxide. 2) Prevention of release of active oxygen from the oxidant (ie. potassium monopersulfate).

It has been found that stability problems arise in mixtures and compressed mixtures of chlorite+oxidant+halide salt (can be any two or three of the ingredients). These problems include premature release of chlorine dioxide gas, yellowing of packaging materials, yellowing of powder or tablets, build-up of chlorine dioxide gas in enclosed containers, and undesired bleaching of surrounding objects. The stability concerns proved unacceptable in attempting to produce a product with adequate shelf-life (ie. >1 year).

Various low-barrier packaging materials that were used to enclose the produced tablet have been found to be inadequate. In particular, low-barrier polymer films, such as PE, PET, and PVETOH (polyvinyl ethanol), were found to be ineffective to varying degrees. The thickness and porosity of the films were thought to be important factors in failure to prevent decomposition of the tablet.

A significant improvement to the stability of the tablet was found when a high-barrier packaging material was used. Aluminum is the ultimate high-barrier material, since it is impervious to moisture and gas, and is, thus, materials containing an aluminum layer are preferred. However, other high-barrier packaging materials can be used. Aluminum polymer films from Alcan Corporation are examples of preferred materials.

High-barrier polymer films are usually comprised of several layers of materials compressed into a composite, and usually include an aluminum layer. Some of the following are examples of materials that are layered into the film: print, paper, lacquer, aluminum, PVC, PE, PET, Sealant (coextrusion of PE and Surlyn), CERAMIS (aluminum-free laminate), adhesive, heat-seal coating.

Preferably, two aluminum flexible laminate films are heat-sealed around a tablet of the present composition to form the sealed biocide article. This type of packing is referred to as Al-Al packing. It is an unexpected result compared to prior art tablets for forming chlorine dioxide, since previous enclosure methods did not yield suitable stability. The films are of various types and functions and are known as “Flexible Laminates” or “Blister Lidding”.

A preferred sealed enclosure used to house the tablets is known as strip packing, as shown in FIG. 3, which comprises two sheets of film 10 and 11 heat-sealed together at 12. The inside space between the two sheets of film 10 and 11 contains the tablet composition 2a of the present invention. The sealed enclosure provides the environment around the composition that prevents the entry of moisture and oxygen.

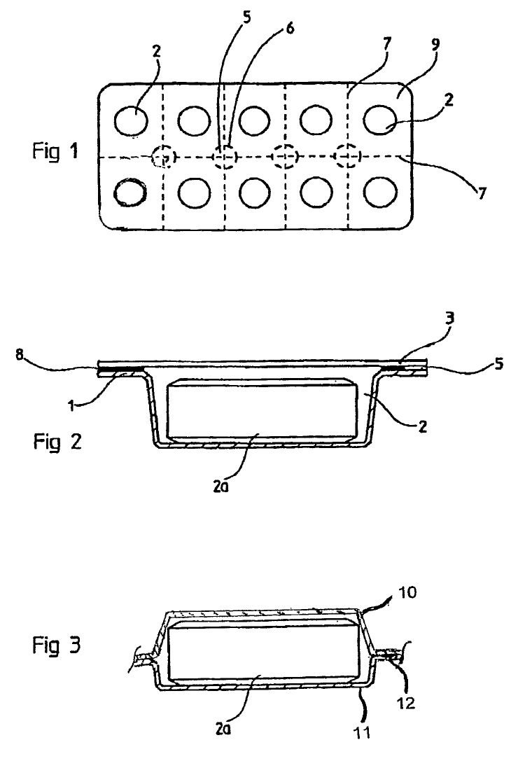

The tablet composition 2a can also be sealed into a larger enclosure known as a blister pack, as shown in FIGS. 1 and 2. These are often used in child-resistant packaging. Larger tablet sizes such as greater than 20 grams are more conveniently packaged into blisters. The blister pack in FIGS. 1 and 2 comprises a foil layer 3 bound to a sheet of film 1 using the adhesive 8. A space 2 between the foil layer 3 and the sheet of film 1 contains the tablet composition 2a. A portion of the foil layer 3 can be left unbound as shown at 5 and the area 6 to provide a flap for opening the blister pack. The blister pack can have perforations shown at 7 to allow separation of the individual blisters.

It was also found that the environmental conditions in the manufacturing and packaging operation can affect the stability of the sealed composition. The ambient temperature and moisture are the most important factors. The relative humidity is preferably kept below about 15% RH and the temperature preferably below about 80° F. Most preferably, the relative humidity should be under about 10% and temperature under 70° F.

For example, the packaging operation can be performed on an automatic double-aluminum packing machine. The two rolls of aluminum flexible laminate films can be fed into the machine and temperature sealed around the tablet at 150-200° F. Double sealed aluminum laminate film strips with the tablet enclosed can be cut into 4″×3″ strips. The strips can then placed inside a labeled paper box.

### EXPERIMENTAL SECTION

All concentration readings were performed on a Hach DR 2500 Spectrometer.

### Example 1

| | |
|---|---|
| Sodium chlorite | 1.0 gram |
| Potassium monopersulfate (KMPS) | 1.5 grams |
| Sodium bromide | 0.9 grams |

Add to 300 ml of water. The result was 1400 mg/Liter (1400 ppm) chlorine dioxide after 5 minutes at pH 6.5.

### Example 2

| | |
|---|---|
| Sodium chlorite | 1.0 gram |
| KMPS | 1.2 grams |
| Sodium bromide | 0.9 grams |

Add to 300 ml of water. The result was 1050 ppm after 5 minutes at pH 7.0.

### Comparative Example A

| | |
|---|---|
| Sodium chlorite | 1.0 gram |
| KMPS | 1.2 grams |
| Sodium chloride | 0.7 grams |

Add to 300 ml of water. The result was 420 ppm after 5 minutes at pH 7.0. To get a higher yield using sodium chloride, the pH would have to be reduced to 4 or lower to achieve an equivalent yield compared to sodium bromide.

### Example 3

| | |
|---|---|
| Sodium chlorite | 1.0 gram |
| Sodium bromochloroisocyanurate | 0.5 grams |

Add to 300 ml of water. The result was 350 ppm after 15 minutes at pH 7.0

### Example 4

| | |
|---|---|
| Sodium chlorite | 1.0 gram |
| Sodium bromochloroisocyanurate | 0.5 grams |
| Sodium bromide | 0.5 grams |

Add to 300 ml of water. The result was 400 ppm after 15 minutes at pH 7.0

### Example 5

| | |
|---|---|
| Sodium chlorite | 1.0 gram |
| Potassium monopersulfate | 1.2 grams |

Add to 300 ml of fresh seawater. The result was 600 ppm after 20 minutes at pH 6.0.

### Example 6

| | |
|---|---|
| Sodium chlorite | 1.0 gram |
| Ammonium bromide | 0.5 gram |
| Potassium monopersulfate | 1.2 gram |

Add to 300 ml of water. The result was 900 ppm after 5 minutes at pH 6.5

### Example 7

| | |
|---|---|
| Sodium chlorite | 1.0 gram |
| Potassium monopersulfate | 2.0 grams |
| Sodium bromide | 0.9 grams |

Add to 300 ml of water. A dark red color was formed immediately that remained for over 2 hours. The characteristic odor of bromine was detected. The solution did not yield any visible or measurable chlorine dioxide. It is believed that the pH was too low, due to the large amount of potassium monopersulfate, thus driving the reaction to form bromine.

### Comparative Example B

This Comparative Example B is taken from Example 4 of published U.S. patent application No. 2006/0016765. In that Example 4, zinc bromide was used in a composition at a pH of 4.1, when measured at less than 0.07 g per 100 ml of water. The pH was low because of the amount of OXONE (potassium monopersulfate) present in the composition at a high percentage, 72.6%. A 2.6 g tablet was dissolved in 3.785 liters of water, which translates to about 0.07 g per 100 ml of water. Since the tablet contained inactive ingredients, the active ingredients were actually present in an amount less than 0.07 g per 100 ml water. If the concentration of the active ingredients was increased to 19 per 100 ml, the pH would have been even lower than 4.1.

In contrast, the Examples according to the present invention provided a pH in the range of 6 to 7, when 1 g of active ingredient was dissolved in 100 ml water.

### Example 8

Tablets were prepared as described above having the formulation below:

Sodium chlorite 31%
Sodium bromide 28%
Potassium monopersulfate 16%
Sodium sulfate 8%
Magnesium sulfate 10%
Magnesium stearate 7%

An experiment was performed to determine biocide efficacy on three microorganisms: Saccharomyces, Zygosaccharomyces, Brettanomyces. The results demonstrate potent biocide action on the three microorganisms.

A solution was prepared by dissolving one tablet in 1 liter of deionized water and tested for microbial efficacy.

The biocide test was performed by G3 Enterprises of Modesto, Calif. The results are shown in Tables 1-3.

TABLE 1

| Time | | Saccharomyces (cfu) | | | | | | |
|---|---|---|---|---|---|---|---|---|
| (Sec) | Concentration | 10⁶ | 10⁵ | 10⁴ | 10³ | 10² | 10¹ | 10⁰ |
| −control | | 0 | | | | | | |
| +control | | 10² × 10⁷ | | | | | | |
| 60 | 1.00 | − | − | − | − | − | − | − |
| 60 | 0.50 | + | + | + | − | − | − | − |
| 60 | 0.25 | + | + | − | − | − | − | − |

TABLE 2

| Time | | Zygosaccharomyces (cfu) | | | | | | |
|---|---|---|---|---|---|---|---|---|
| (Sec) | Concentration | 10⁶ | 10⁵ | 10⁴ | 10³ | 10² | 10¹ | 10⁰ |
| −control | | 0 | | | | | | |
| +control | | ⁹⁵ × 10⁷ | | | | | | |
| 60 | 1.00 | − | − | − | − | − | − | − |
| 60 | 0.50 | + | + | − | − | − | − | − |
| 60 | 0.25 | + | + | − | − | − | − | − |

TABLE 3

| Time | | Brettanomyces (cfu) | | | | | | |
|---|---|---|---|---|---|---|---|---|
| (Sec) | Concentration | 10⁶ | 10⁵ | 10⁴ | 10³ | 10² | 10¹ | 10⁰ |
| −control | | 0 | | | | | | |
| +control | | ⁵⁷ × 10⁷ | | | | | | |
| 60 | 1.00 | − | − | − | − | − | − | − |
| 60 | 0.50 | − | − | − | − | − | − | − |
| 60 | 0.25 | + | − | − | − | − | − | − |

### ADVANTAGES OF THE PRESENT INVENTION

Generation of chlorine dioxide occurs rapidly at neutral pH.

The present invention avoids the use of dangerous chlorine-releasing compounds such as hypochlorites and chlorinated isocyanurates and thus no free chlorine is generated in the solution.

The present invention avoids adding acidulant materials to the composition thereby increasing stability and decreasing corrosive properties.

Generation of chlorine dioxide occurs rapidly at high yield with no residue.

The present composition has a greater safety profile than previously described compositions. Sodium dichloroisocyanurate has a NFPA rating of (3-1-2) and is classified by DOT as an oxidizer. Potassium monopersulfate has a NFPA rating of (3-0-1) and is classified by DOT as a corrosive solid.

The present composition does not possess a chlorine-like odor as do previously described compositions.

Chlorine dioxide release at high yield can be achieved using only two precursors, unlike most formulations that require three or more precursor compounds to be present.

While the claimed invention has been described in detail and with reference to specific embodiments thereof, it will be apparent to one of ordinary skill in the art that various changes and modifications can be made to the claimed invention without departing from the spirit and scope thereof.

1. A solid composition for forming chlorine dioxide on demand comprising:
a solid inorganic source of hypobromous acid; and
a solid source of chlorite, wherein the solid inorganic source of hypobromous acid and solid source of chlorite are present in an amount such that the pH of a solution formed from dissolving the composition in water is from 5 to 9, measured at 25° C. at a concentration of 1 g of active ingredients of the composition per 100 ml of water, the active ingredients being the total weight of the solid inorganic source of hypobromous acid and the solid source of chlorite.

2. A solid composition according to claim 1, wherein the solid source of chlorite comprises a metal chlorite and the solid inorganic source of hypobromous acid comprises an oxidizing agent and a bromide salt.

3. A solid composition according to claim 2, wherein the oxidizing agent is at least one oxidizing agent selected from the group consisting of alkali and alkali earth persulfates, monopersulfates, alkali and alkali earth peroxides, urea peroxide, percarbonates, persilicates, perphosphates, and hydrogen peroxide.

4. A solid composition according to claim 2, wherein the bromide salt comprises at least one bromide salt selected from the group consisting of alkali and alkali earth metal bromides.

5. A solid composition according to claim 2, wherein the bromide salt comprises at least one selected from the group consisting of sodium bromide, lithium bromide, potassium bromide, calcium bromide, magnesium bromide, ammonium bromide, and aluminum bromide.

6. A solid composition for forming chlorine dioxide on demand according to claim 1, wherein the solid source of chlorite comprises an alkali or alkali earth metal chlorite and the solid inorganic source of hypobromous acid comprises an oxidizing agent and a solid bromide-releasing compound.

7. A solid composition according to claim 6, wherein the solid bromide-releasing compound comprises at least one selected from the group consisting of brominated hydantoins, bromochlorohydantion—BCDMH, dibromodimethylhydantoin, brominated isocyanurates and bromochloroisocyanuric acid.

8. A solid composition according to claim 2, wherein the oxidizing agent comprises at least one selected from the group consisting of dialkylperoxides, diacylperoxide, performed percarboxylic acids, organic and inorganic peroxides, hydroperoxides, organic peroxides, hydroperoxides, diacyl and dialkyl peroxides, dibenzoyl peroxide, t-butyl hydroperoxide, dilauroyl peroxide, dicumyl peroxide, and mixtures thereof.

9. A solid composition according to claim 2, further comprising at least one peroxy-acid selected from the group consisting of diperoxydodecandioic acid (DPDDA), magnesium perphthalic acid, perlauric acid, perbenzoic acid, diperoxyazelaic acid and mixtures thereof.

10. A solid composition according to claim 2, wherein the bromide salt comprises a bromine-rich sea salt or brine.

11. A solid composition according to claim 6, wherein the bromide-releasing compound comprises at least one selected from the group consisting of ammonium bromide, alkylammonium bromide, dialkylammonium bromide, trialkylammonium bromide, wherein said alkyl radicals are independently selected from straight chain or branched aliphatic, aromatic, or aryl hydrocarbon radicals of between 1 to about 24 carbon atoms.

12. A solid composition according to claim 6, wherein the bromide-releasing compound comprises a bromide ion exchange material.

13. A solid composition according to claim 1, further comprising a solid inorganic source of hypochlorous acid wherein one of the sources is a salt.

14. A solid composition according to claim 1, further comprising a source of hypoiodous acid.

15. A solid composition according to claim 1, wherein the source of hypobromous acid comprises a hypobromite compound.

16. A solid composition according to claim 15, wherein the hypobromite compound comprises at least one selected from the group consisting of alkali and alkali earth metal hypobromite salts such as: lithium hypobromite, sodium hypobromite, potassium hypobromite, calcium hypobromite, magnesium hypobromite, zinc hypobromite, and mixtures thereof.

17. A solid composition according to claim 1, further comprising at least one hypochlorite-generators selected from the group consisting of chlorinated trisodium phosphate, chlorinated trisodium polyphosphate, and chlorinated trisodium phosphate dodecahydrate, and mixtures thereof.

18. A solid composition according to claim 1, wherein the source of hypobromous acid comprises a bromocyanurate or salt of a bromocyanurate.

19. A solid composition according to claim 18, wherein the bromocyanurate or salt of the bromocyanurate comprises at least one selected from the group consisting of tribromoisocyanuric acid, dibromoisocyanuric acid, monobromoisocyanuric acid, monobromo-dichlorisocyanuric acid, dibromo-monochloroisocyanuric acid, and monobromo-monochloro-isocyanuric acid.

20. A solid composition according to claim 1, wherein the source of hypobromous acid comprises at least one selected from the group consisting of hypobromite-generating compounds include: 1,3,5-Triazine-2,4,6(1H,3H,5H)-trione, 1,3-dibromo-, sodium salt (sodium dibromoisocyanurate—CAS# 15114-34-8); 1,3,5-Triazine-2,4,6(1H,3H,5H)-trione, 1,3-dibromo-, potassium salt (potassium dibromoisocyanurate—CAS# 15114-46-2); 1,3,5-Triazine-2,4,6(1H,3H,5H)-trione, 1-bromo-3-chloro-, sodium salt (sodium bromochloroisocyanuric acid—CAS #20367-88-8); 1,3,5-Triazine-2,4,6(1H,3H,5H)-trione, 1-bromo-3-chloro-, potassium salt (potassium bromochloroisocyanurate—CAS# 29545-74-2); 1,3,5-Triazine-2,4,6(1H,3H,5H)-trione, 1,3-dibromo-5-chloro-(bromochlorisocyanuric acid—CAS 666714-66-5); 1,3,5-Triazine-2,4,6(1H,3H,5H)-trione, 1,3-dibromo-(dibromocyanuric acid—CAS #15114-43-9); and sodium monobromo-monochloro-isocyanurate (bromochloroisocyanuric acid monosodium salt hydrate—CAS# 164918-61-0).

21. A solid composition according to claim 1, wherein the source of hypobromous acid comprises at least one hypobromite-generating organic compound selected from the group consisting of N-bromophthalamide, N,N-dibromodiethylhydantion, N,N-dibromodimethylglycoluracil, dibromotriethylene-diamine dihydrogenchloride, and mixtures thereof.

22. A solid composition according to claim 1, further comprising at least one hypochlorite-generating compound selected from the group consisting of trichlorocyanuric acid, dichlorocyanuric acid, mono-chlorocyanuric acid, sodium dichloroisocyanurate (dihydrate and anhydrous), potassium dichloroisocyanurate, N,N-dichloro-s-trizinetrione, N-chlorophtalamide, N-dichloro-p-toluene sulfonamide, 2,5-N,N-dichloroazodicarbonamidine hydrochloride, NNNN-tetrachloroglycoluracil, N,N-dichloroyl,N,N,N-trichloromelamine, N-chlorosuccinimide, methylene-bis(1-chloro-5,5,-dimethyethylhydantoin), 1,3-dichloro-5-methyl-5-isobutylhydantoin, 1,3,dichloro-5-n-amylhydantoin, 1,3-dichloro-5,5-dimethylhydantoin, 1,4-dichloro-5,5-diethylhydantoin, 1-1monochlor-5,5-dimethylhydantoin, sodium-para-toluenesulfochloramine, dichlorosuccinamide, 1,3,4,6-tetrachlorogylcouracil, potassium and sodium salts of chloroisocyanuric acid, dichlorocyanuric acid, and trichlorocyanuric acid, potassium and sodium salts of N-brominated and N-chlorinated succinimide, malonimide, phthalimide and naphthalimide, and mixtures thereof.

23. A solid composition according to claim 1, comprising at least one halohydantoin.

24. A solid composition according to claim 1, comprising at least one halohydantoins selected from the group consisting of 1-bromo-3-chloro-5-methyl-5-ethyl-hydantoin (BCEMH), 1,3-dibromo-5,5-dimethylhydantoin (DBDMH), 1,3-dibromo-5-methyl-5-ethyl-hydantoin (DBEMH), and mixtures thereof.

25. A solid composition according to claim 1, comprising at least one N-haloamines selected from the group consisting of trichloromelamine, tribromomelamine, dibromo- and dichloro-dimethyhydantoin, chlorobromo-dimethylhydantoin, N-chlorosulfamide(haloamide), chloramines(haloamine), and mixtures thereof.

26. A solid composition according to claim 1, comprising at lest one partially chlorinated and brominated compound selected from the group consisting of including N-bromo-N-chlorodiethylhydantoin, N-bromo-N-chlorodiphenylhydantoin, N-bromo-N,N-dichloro-dimethylglycouracil, N-bromo-N-chlorosodium cyanurate, bromochlorotriethylenediamine dihydrogenchloride, and mixtures thereof.

27. A solid composition according to claim 1, comprising a bromide salt combined with a chloride or iodide salt.

28. A solid composition according to claim 27, wherein the chloride or iodide salt comprises sodium, potassium, lithium, magnesium, calcium, zinc, ammonium, aluminum chloride, and mixtures thereof.

29. A solid composition comprising:
about 10 to about 90% by weight of sodium chlorite;
about 10 to about 90% by weight of sodium bromide; and about 5 to about 90% by weight of potassium monopersulfate, the weight percent being based on the total weight of the composition, wherein the sodium chlorite, sodium bromide and potassium monopersulfate are present in an amount such that the pH of a solution formed from dissolving the composition in water is from 5 to 9, measured at 25° C. at a concentration of 1 g of active ingredients of the composition per 100 ml of water, the active ingredients being the total weight of the sodium chlorite, sodium bromide and potassium monopersulfate.

30. A solid composition according to claim 2, comprising:
about 20 to about 60% by weight sodium chlorite;
about 10 to about 60% by weight potassium monopersulfate; and about 10 to about 40% by weight of at least one of sodium bromide or ammonium bromide.

31. A solid composition according to claim 2, wherein the bromide salt is other than calcium bromide and zinc bromide.

32. A solid composition according to claim 1, wherein the solid inorganic source of hypobromous acid and solid source of chlorite are present in an amount such that the pH of a solution formed from dissolving the composition in water is from 6 to 8, measured at 25° C. at a concentration of 1 g of active ingredients of the composition per 100 ml of water.

33. A solid composition according to claim 1, wherein the solid inorganic source of hypobromous acid and solid source of chlorite are present in an amount such that the pH of a solution formed from dissolving the composition in water is from 6.5 to 7.5, measured at 25° C. at a concentration of 1 g of active ingredients of the composition per 100 ml of water.

34. A solid composition according to claim 1, wherein the solid source of chlorite comprises sodium chlorite and the solid inorganic source of hypobromous acid comprises a bromocyanurate

35. A solid composition according to claim 34, wherein the bromocyanurate is bromochlorocyanurate.

36. A solid composition according to claim 1, wherein the composition comprises from about 10 to about 90% of the solid inorganic source of hypobromous acid and about 10 to about 90% of the solid source of chlorite.

37. A sealed biocide article comprising a tablet having a composition according to claim 2 sealed in a high-barrier package.

38. A sealed biocide article according to claim 37, wherein the tablet is sealed in a blister pack.

39. A sealed biocide article according to claim 37, wherein the tablet is sealed in a strip pack.

40. A method of producing chlorine dioxide comprising: adding a composition comprising a solid inorganic source of hypobromous acid and a solid source of chlorite, wherein the solid inorganic source of hypobromous acid and solid source of chlorite are present in an amount such that the pH of a solution formed from dissolving the composition in water is from 5 to 9, measured at 25° C. at a concentration of 1 g of active ingredients of the composition per 100 ml of water, the active ingredients being the total weight of the solid inorganic source of hypobromous acid and the solid source of chlorite, to water such that hypobromous acid is produced from the solid inorganic source of hypbromous acid and the hypobromous acid is reacted with chlorite produced from the solid source of chlorite to form chlorine dioxide.

41. A method according to claim 40, wherein the solid source of chlorite comprises sodium chlorite and the solid inorganic source of hypbromous acid comprises sodium bromide and potassium monopersulfate.

42. A method according to claim 40, further comprising the step of using hypochlorous acid to convert a bromide salt to hypobromous acid.

43. A method according to claim 40, further comprising the steps of adding sodium chlorite and potassium monopersulfate to seawater.
